(19) United States
(12) Patent Application Publication
(10) Pub. No.: US 2009/0279053 A1
(43) Pub. Date: Nov. 12, 2009

(54) Apparatus for Continuously Projecting Images and Method therefor

(76) Inventors: Ching-cherng SUN, Jhongli City (TW); Hsin-Ying Ho, Jhongli City (TW); Chang-yu Tsai, Jhongli City (TW)

Correspondence Address: HDLS Patent & Trademark Services, P.O. BOX 220746, CHANTILLY, VA, 20153-0746, US

(21) Appl. No.: 12/139,546

(22) Filed: Jun. 16, 2008

(30) Foreign Application Priority Data
May 7, 2008 (TW) 097116825

(51) Int. Cl. G03B 21/00; H04N 9/74

(52) U.S. Cl. 353/46; 353/121; 348/578

(57) ABSTRACT

A method for continuously projecting images by enabling an apparatus including a light source, an image creation unit, and a projection unit includes receiving video signals from a predetermined source; creating a plurality of images from the video signals while being impinged by light emitted by the light source; receiving the images from the image creation unit; and activating the projection unit to project the images on a projection screen in a predetermined rapid succession so as to create a motion picture effect. As such, lighting adjustment and natural beauty simulations in a vivid way can be achieved.

### BACKGROUND OF THE INVENTION

1. Field of Invention

The invention relates to projectors and more particularly to an apparatus for continuously projecting high resolution images on a projection screen so that special effects such as lighting adjustment and natural beauty simulations can be achieved, and method therefor.

2. Description of Related Art

Slide projectors are well known in the art. A slide projector is a device that projects a still image with a transparent base. In detail, a slide projector comprises a motor for rotating a slide carousel, a lamp for emitting light through the slide, a condenser for concentrating light on the slide, and a lens for projecting a still image on a projection screen or planar surface. An optical illusion, because of persistence of vision, of moving persons and objects can be created on the screen if the number of slides is sufficiently large and the motor is capable of rotating the slides in such a rapid succession.

However, the typical slide projectors suffer from a number of disadvantages. In detail, the effect similar to motion picture can be obtained only if the number of slides is very large. Unfortunately, the larger of the number of slides the higher of the manufacturing cost and the larger of the size of the projector will be. Further, a visible ghosting can be created when images rapidly change. Furthermore, eye fatigue can occur. In addition, image quality is poor due to lag.

Thus, it is desirable to provide a novel apparatus for continuously projecting high resolution images on a projection screen so that special effects such as lighting adjustment and natural beauty simulations can be achieved, and a method therefor in order to overcome the inadequacies (e.g., eye fatigue, poor image quality, etc.) of the prior art.

### SUMMARY OF THE INVENTION

It is therefore one object of the invention to provide an apparatus for continuously projecting images for achieving lighting adjustment and natural beauty simulations, comprising a light source for emitting light; an image creation unit for receiving video signals from a predetermined source and creating images from the video signals while being impinged by the light emitted by the light source; and a projection unit for receiving the images from the image creation unit and projecting same on a projection screen in a predetermined rapid succession so as to create a motion picture effect.

In one aspect of the invention there are further provided a storage unit for storing a plurality of images; and an arranging unit for receiving the images from the storage unit, arranging same based on a predetermined order, and sending the arranged images to the image creation unit for adding additional information or images to the images being shown continuously on the projection screen.

In another aspect of the invention focus of the images projected on the projection screen is adapted to adjust.

In a further aspect of the invention the apparatus is highly adaptable to lighting adjustment and is capable of simulating natural beauty including simulating season changes or whether changes.

It is another object of the invention to provide a method for continuously projecting images, comprising the steps of receiving video signals from a predetermined source; creating a plurality of images from the video signals while being impinged by light emitted by a light source; receiving the images from an image creation unit; and activating a projection unit to project the images on a projection screen in a predetermined rapid succession so as to create a motion picture effect.

The above and other objects, features and advantages of the invention will become apparent from the following detailed description taken with the accompanying drawings.

### BRIEF DESCRIPTION OF THE DRAWINGS

FIG. 1 is a schematic diagram of a first preferred embodiment of apparatus for continuously projecting images according to the invention;

FIG. 2 is a flowchart depicting a process for continuously projecting images according to the first preferred embodiment of the apparatus of the invention;

FIG. 3 is a schematic diagram of a second preferred embodiment of apparatus for continuously projecting images according to the invention; and

FIG. 4 is a flowchart depicting a process for continuously projecting images according to the second preferred embodiment of the apparatus of the invention.

### DETAILED DESCRIPTION OF THE INVENTION

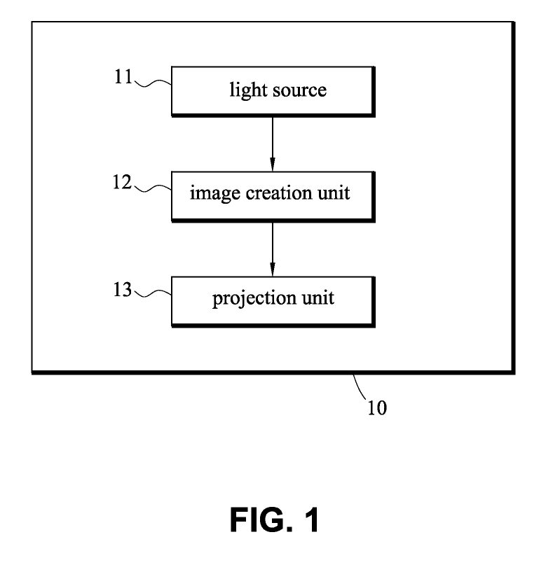

Referring to FIG. 1, an apparatus for continuously projecting images in accordance with a first preferred embodiment of the invention is generally designated 10 and is shown schematically. The apparatus 10 comprises a light source 11, an image creation unit 12, and a projection unit 13. Each component is discussed in detail below.

The light source 11 is adapted to emit light rays. The light source 11 is selected from a group consisting of LED (light-emitting diode) lamp, fluorescent bulb, and incandescent light. Moreover, the light source 11 can be either an adjustable light source for adjusting contrast ratios of images or a light source with controlled lighting for obtaining a dark viewing effect.

The image creation unit 12 is adapted to receive video signals from an external video source or a memory thereof, and create images from the video signals. Moreover, light emitted by the light source 11 is directed toward the image creation unit 12. The projection unit 13 is adapted to receive images from the image creation unit 12 and project same on a projection screen in such a rapid succession so as to create an optical illusion, because of persistence of vision, of moving persons and objects on the screen. In addition, the projection unit 13 can be manipulated to adjust the properties (e.g., focus adjustment) of moving images displayed on the screen. The projection unit 13 is a lens such as a single lens, a composite lens, or a lens assembly which is a device that is adapted to obtain an optimum imaging effect by adjusting a distance between any two lenses thereof.

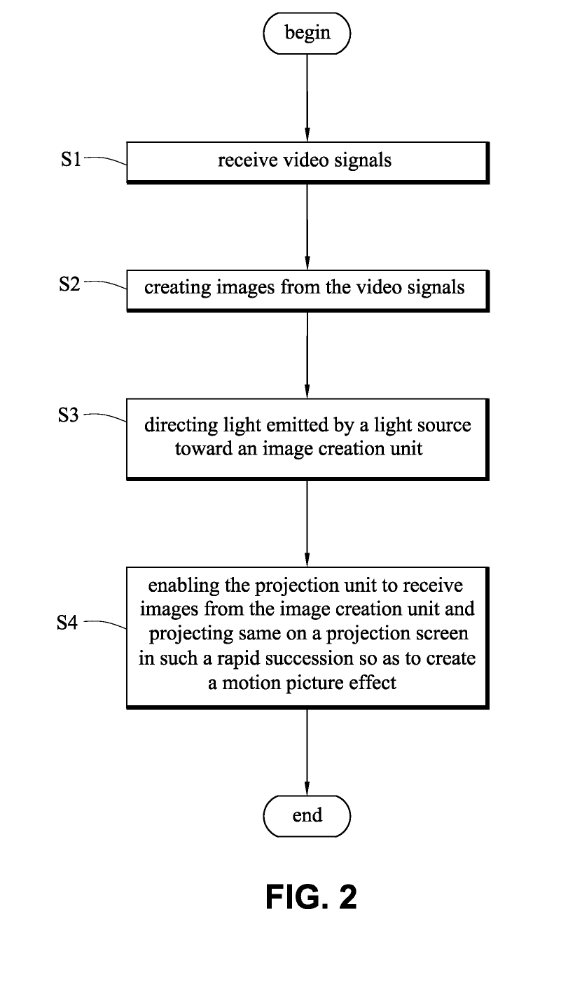

Referring to FIG. 2, it is a flowchart depicting a process for continuously projecting images according to the first preferred embodiment of the apparatus 10 of the invention. The process comprises the following steps:

In step S1, enabling the image creation unit 12 to receive video signals from an external video source or a memory thereof.

In step S2, creating images from the video signals.

In step S3, directing light rays emitted by the light source 11 toward the image creation unit 12.

In step S4, enabling the projection unit 13 to receive images from the image creation unit 12 and projecting same on a projection screen in such a rapid succession so as to create an optical illusion, because of persistence of vision, of moving persons and objects on the screen, and manipulating the projection unit 13 adjust focus of moving images displayed on the screen.

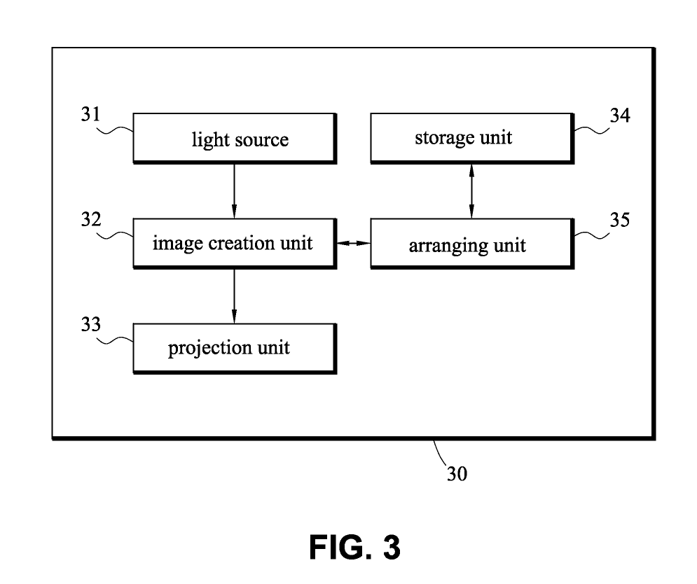

Referring to FIG. 3, an apparatus for continuously projecting images in accordance with a second preferred embodiment of the invention is generally designated 30 and is shown schematically. The apparatus 30 comprises a light source 11, an image creation unit 12, a projection unit 13, a storage unit 34, and an arranging unit 35. Each component is discussed in detail below.

The light source 11 is adapted to emit light rays. The light source 11 is selected from a group consisting of LED lamp, fluorescent bulb, and incandescent light. Moreover, the light source 11 can be either an adjustable light source for adjusting contrast ratios of images or a light source with controlled lighting for obtaining a dark viewing effect.

The image creation unit 12 is adapted to receive video signals from an external video source or a memory thereof, and create images from the video signals. Moreover, light emitted by the light source 11 is directed toward the image creation unit 12. The projection unit 13 is adapted to receive images from the image creation unit 12 and project same on a projection screen in such a rapid succession so as to create an optical illusion, because of persistence of vision, of moving persons and objects on the screen. In addition, the projection unit 13 can be manipulated to adjust the properties (e.g., focus adjustment) of moving images displayed on the screen. The projection unit 13 is a lens such as a single lens, a composite lens, or a lens assembly which is a device that is adapted to obtain an optimum imaging effect by adjusting a distance between any two lenses thereof.

The storage unit 34 is adapted to store a plurality of images. The arranging unit 35 is adapted to receive the images from the storage unit 34 and arrange same based on a predetermined order. The arranged images are then fed to the image creation unit 12.

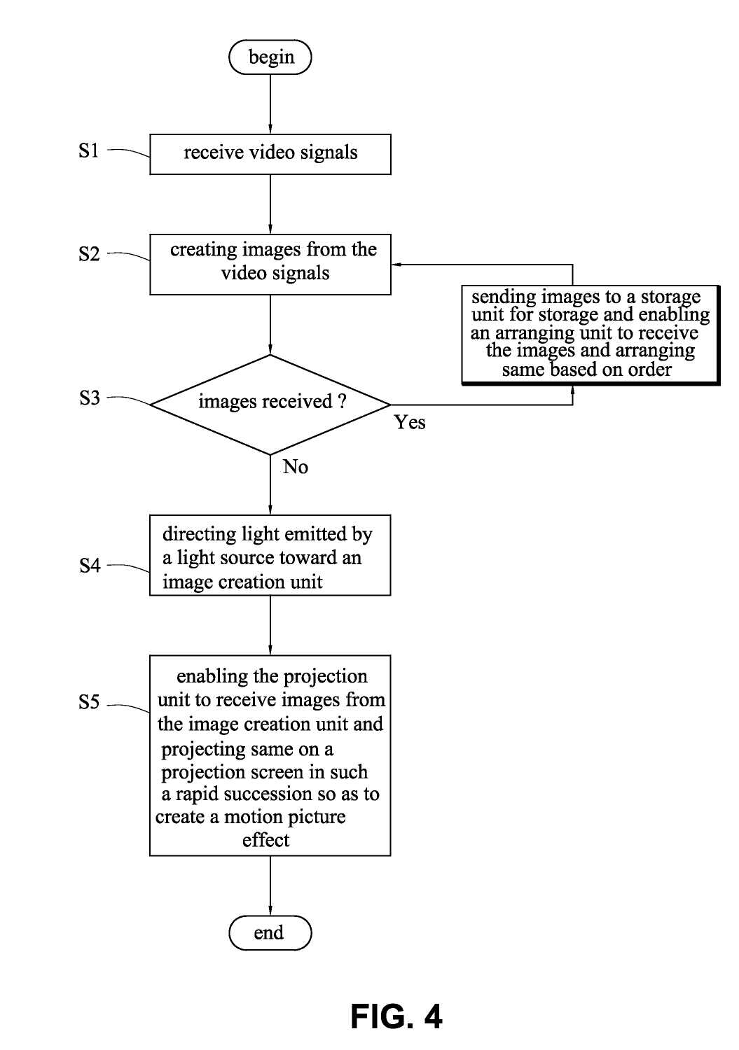

Referring to FIG. 4, it is a flowchart depicting a process for continuously projecting images according to the second preferred embodiment of the apparatus 30 of the invention. The process comprises the following steps:

In step S1, enabling the image creation unit 12 to receive video signals from an external video source or a memory thereof.

In step S2, creating images from the video signals.

In step S3, it is determined whether a plurality of images are received or not. If no, the process goes to step S4. Otherwise, the images are sent to storage unit 34 for storage. Further, enabling the arranging unit 35 to receive the images from the storage unit 34 and arranging same based on a predetermined order prior to looping back to step S2.

In step S4, directing light rays emitted by the light source 11 toward the image creation unit 12.

In step S5, enabling the projection unit 13 to receive images from the image creation unit 12 and projecting same on a projection screen in such a rapid succession so as to create an optical illusion, because of persistence of vision, of moving persons and objects on the screen, and manipulating the projection unit 13 adjust focus of moving images displayed on the screen.

The apparatus 10 of the invention has many applications as detailed below. A user may send video signals (e.g., a signal about night sky) either from an external video source to the light source 12 or from a memory of the light source 12 to itself. The apparatus 10 then continuously projects the images rendered from the video signals on a projection screen in a predetermined rapid succession. As a result, a beautiful night sky view is simulated. This can bring a degree of comfort to a viewer and even can help sleep. Moreover, a user may add video signals representing starry night, full moon night, or meteoric shower in the projects during the projection. Hence, a night view with changing scenes is created as a result of the night sky simulation.

Alternatively, in the case of apparatus 30, a user may send a plurality of images representing season changes either from an external video source or from a memory of the light source 12 to the storage unit 34 for storage. Next, the images are arranged by the arranging unit 35 based on a predetermined order. As a result, the continuous images representing rapid changing season are shown on the screen.

The luminance of the apparatus 10 or 30 is different from the typical projectors. The apparatus 10 or 30 is highly adaptable to lighting adjustment and is capable of simulating natural beauty. For example, a user may adjust the apparatus 10 or 30 to cause the light source 11 to emit light rays onto a projection screen. Luminance of the light is substantially the same as that measured in a real situation. Information about time and date can additionally added in the images so that time and date may be shown on a ceiling or wall along with the images projected by the apparatus 10 or 30.

The invention is characteristically different from the prior art techniques as detailed below.

The invention is novel because it utilizes stored video signals to render images and continuously projects same in such a rapid succession so as to create an optical illusion, because of persistence of vision, of moving persons and objects on the screen. This is technologically different from the well known projectors.

The invention is industry applicable because the moving images are highly adaptable such that special effects such as lighting adjustment and natural beauty simulations can be achieved. This can bring a degree of comfort to a viewer and even can help sleep.

The invention is non-obvious because it utilizes stored video signals to render images and continuously projects same in such a rapid succession so as to create an optical illusion, because of persistence of vision, of moving persons and objects on the screen. Moreover, additional data or images representing season changes or the like can be added in the original images so that the shown images can has a high resolution and are more vivid. As a contrast, the typical projectors can only project a still image with a transparent base and it is thus monotonous.

While the invention herein disclosed has been described by means of specific embodiments, numerous modifications and variations could be made thereto by those skilled in the art without departing from the scope and spirit of the invention set forth in the claims.

What is claimed is:

1. An apparatus for continuously projecting images for achieving lighting adjustment and natural beauty simulations, comprising:
a light source for emitting light;
an image creation unit for receiving video signals from a predetermined source and creating images from the video signals while being impinged by the light emitted by the light source; and
a projection unit for receiving the images from the image creation unit and projecting same on a projection screen in a predetermined rapid succession so as to create a motion picture effect.

2. The apparatus of claim 1, wherein the light source is an LED lamp, a fluorescent bulb, or an incandescent light.

3. The apparatus of claim 1, wherein the light source is either an adjustable light source or a light source with controlled lighting.

4. The apparatus of claim 1, wherein the predetermined source is an external video source.

5. The apparatus of claim 1, wherein the predetermined source is a memory of the image creation unit.

6. The apparatus of claim 1, wherein the projection unit is a lens which is a single lens, a composite lens, or a lens assembly.

7. The apparatus of claim 1, further comprising
a storage unit for storing a plurality of images; and
an arranging unit for receiving the images from the storage unit, arranging same based on a predetermined order, and sending the arranged images to the image creation unit.

8. The apparatus of claim 1, wherein the images projected in the predetermined rapid succession are adapted to create an optical illusion of moving persons and objects on the projection screen due to persistence of vision.

9. A method for continuously projecting images comprising the steps of:
receiving video signals from a predetermined source;
creating a plurality of images from the video signals while being impinged by light emitted by a light source;
receiving the images from an image creation unit; and
activating a projection unit to project the images on a projection screen in a predetermined rapid succession so as to create a motion picture effect.

10. The method of claim 9, wherein the predetermined source is an external video source.

11. The method of claim 9, wherein the predetermined source is a memory of the image creation unit.

12. The method of claim 9, wherein in response to receiving the images further comprises the steps of sending the images to a storage unit for storage, and activating an arranging unit to receive the images from the storage unit, arrange same based on a predetermined order, and send the arranged images to the image creation unit.

13. The method of claim 9, wherein the images projected in the predetermined rapid succession are adapted to create an optical illusion of moving persons and objects on the projection screen due to persistence of vision.

14. The method of claim 9, wherein focus of the images projected on the projection screen is adapted to adjust.
